(19) United States
(12) Patent Application Publication
(10) Pub. No.: US 2021/0169191 A1
(43) Pub. Date: Jun. 10, 2021

(54) LUGGAGE ITEM WITH RADIO-TAG READER

(71) Applicant: OJH SAS, RIXHEIM (FR)

(72) Inventor: Valerie MANNARELLI, Rixheim (FR)

(73) Assignee: OJH SAS, RIXHEIM (FR)

(21) Appl. No.: 16/071,846

(22) PCT Filed: Jan. 23, 2017
(86) PCT No.: PCT/FR2017/050135

§ 371 Date: Aug. 2, 2018

(30) Foreign Application Priority Data
Jan. 22, 2016 (FR) 1650517

(51) Int. Cl. A45C 13/18; A45C 3/06; A45C 15/00; G06K 7/10

(52) U.S. Cl. CPC A45C 13/18; A45C 3/06; A45C 2200/05; G06K 7/10366; A45C 15/00

(57) ABSTRACT

The invention relates to a luggage item (1) intended to contain removable objects (7, 8), the luggage item (1) comprising a casing (5) delimiting an internal space of the luggage item (1) able to contain the removable objects (7, 8), the casing (5) exhibiting an opening (6) forming a passage between the internal space of the luggage item (1) and an exterior environment of the luggage item (1), the luggage item furthermore comprising a radio-tag reader (2), the radio-tag reader (2) comprising: —an identification module (12) configured to emit by radiofrequency an identification request destined for a radio-tag (4) and to receive identification data from the radio-tag (4) in response to the identification request, —a communication module (13) configured to associate the radio-tag reader (2) with a remote device (3) by means of a wireless connection (17), the radio-tag reader (2) being configured to transmit the identification data received in response to the identification request to the remote device (3), —a power supply (14) able to energise components of the radio-tag reader.

### TECHNICAL FIELD

The invention relates to the field of portable containers, and more particularly of luggage items.

### TECHNOLOGICAL BACKGROUND

Luggage items allow for the practical transport of miscellaneous and varied items intended to be used thereafter, depending on the situation. Thus, suitcases make it possible to transport clothing or other objects that may be used during extended travel. Purses or backpacks are intended to gather and transport objects of smaller size that may be used on a daily or limited basis, for example identification documents, means of payment such as bank cards, keys, pens or the like.

The objects transported in these luggage items may be for occasional use, such that they are only placed in the luggage items occasionally. These objects are generally removed from the luggage items when they are no longer necessary in the near future.

Conversely, objects requiring regular use are generally kept in the luggage item continuously. These objects are only removed from the luggage item when it is necessary to use them. It is then necessary to make sure that once used, the object is indeed placed back in the luggage item for its next use.

Thus, depending on the needs, the objects transported in the luggage item vary regularly, and the content of the luggage item varies based on the objects placed in, then removed from the luggage item. These regular movements of objects out of or into the luggage item are a source of uncertainty and risks, since it is necessary to check that the luggage item indeed contains the objects corresponding to a given need when the luggage item is picked up by its owner.

### SUMMARY

One idea at the base of the invention is to propose methods and systems that make it possible to check the contents of a luggage item simply, efficiently and reliably.

According to one embodiment, the invention provides a luggage item intended to contain removable objects, the luggage item comprising a casing delimiting an internal space of the luggage item capable of containing the removable objects, the casing having an opening forming a passage between the internal space of the luggage item and an exterior environment of the luggage item, the luggage item further including a radio-tag reader, the radio-tag reader comprising:
an identification module configured to emit, by radio frequency, an identification request destined for a radio-tag and to receive identification data from the radio-tag in response to the identification request,
a communication module configured to associate the radio-tag reader with a remote device by means of a wireless connection, the radio-tag reader being configured to transmit the identification data received in response to the identification request to the remote device,
a power supply capable of powering components of the radio-tag reader.

Thus, such a luggage item makes it possible, by using a simple identification request, to check all of the contents of the luggage item marked by a radio-tag and to transmit the identification data corresponding to the objects marked by the radio-tags to a remote device. It then suffices to make a simple request on the remote device to check that the luggage item indeed contains the objects it is supposed to contain. If the remote device is for example a mobile telephone or a smartwatch worn by the owner of the luggage item, simply viewing said remote device immediately makes it possible to know the contents of the luggage item without having to look in the luggage item for all of the objects marked with a radio-tag to check whether they are indeed present in the luggage item.

According to other advantageous embodiments, such a luggage item may exhibit one or more of the following features.

According to one embodiment, the luggage item comprises a movement sensor configured to detect a movement of the luggage item, the radio-tag reader being connected to the movement sensor of the luggage item and configured to emit an identification request in response to the detection of a movement by the movement sensor.

According to one embodiment, the movement sensor comprises an accelerometer configured to detect an acceleration.

According to one embodiment, the movement sensor is arranged on the radio-tag reader.

Owing to these features, when the luggage item is moved, the remote device is informed of the contents of the luggage item marked by a radio-tag. Thus, when the owner of the luggage item performs a journey between two places, the remote device is informed when the luggage item departs and during the entire journey of the contents of the luggage item. Furthermore, if an object marked with a radio-tag is removed from the luggage item during the journey, for example if the object falls out of the luggage item or is stolen by a third party, the remote device is immediately informed of the fact that this object is no longer indicated in the list of objects contained in the luggage item.

Alternatively or additionally, the luggage item comprises a position sensor configured to detect a position of the luggage item relative to one or several reference marks, the radio-tag reader being connected to the position sensor of the luggage item and for example configured to emit an identification request in response to the detection of a position of the luggage item relative to a reference mark.

According to one embodiment, the radio-tag reader is arranged on the casing so as to detect the passage of a radio-tag by the opening of the casing.

According to one embodiment, the radio-tag reader is located on the casing at one end of the casing delimiting the opening of the casing. Owing to this feature, when the opening of the luggage item is manipulated to introduce or remove an object into or from the luggage item, the movement sensor is also moved. Thus, when an object is introduced into or removed from the luggage item, an identification request is generated by the radio-tag reader in order to notify the remote device. This feature is particularly useful to prevent any theft of objects in the luggage item.

According to one embodiment, the casing of the luggage item comprises a bottom, a side wall developing from the bottom of the casing, an end of the wall opposite to the bottom delimiting the opening of the casing.

According to one embodiment, the radio-tag reader is located on the wall of the casing at the end delimiting the opening of the casing.

Thus, when the radio-tag reader comprises a movement sensor, the radio-tag reader is ideally placed to generate an identification request when a movement of the opening is detected.

According to one embodiment, the radio-tag reader is removable. It can thus be provided with a dedicated housing. Such a removable radio-tag reader can thus be used on a plurality of separate luggage items, based on the luggage items used at a given moment. Furthermore, the radio-tag reader can thus be removed from the luggage item to facilitate recharging of its power supply. It can also be removed from the luggage item and manipulated in an environment in order to find a lost object.

According to one embodiment, the communication module of the radio-tag reader is configured to receive a request to check the contents of the luggage item, the radio-tag reader being configured to emit an identification request in response to the reception of the request to check the contents of the luggage item. Owing to this feature, it is possible to check the contents of the luggage item upon simple request from the remote device.

According to one embodiment, the radio-tag reader is configured to emit identification requests at regular intervals, the radio-tag reader being configured to transmit to the remote device the identification data received in response to each identification request. Owing to this feature, it is possible to check the contents of the luggage item regularly, even when the luggage item is deposited in a location.

According to one embodiment, the radio-tag reader comprises a memory. According to one embodiment, the radio-tag reader is configured to store the identification data received in response to the identification request resulting from one of said identification requests.

According to one embodiment, the communication module is configured to associate the radio-tag reader with two separate remote devices, the radio-tag reader being configured to transmit the identification data received in response to the identification request to one and/or the other of the remote devices.

According to one embodiment, the invention also provides a connected luggage item assembly including:
a luggage item as described above,
a radio-tag comprising a transceiver able to receive a radiofrequency identification request and to transmit, in response, upon receiving the identification request, a so-called identification datum stored in a memory of the radio-tag.

According to other advantageous embodiments, such a may comprise one or more of the following features.

According to one embodiment, the radio-tag is a passive radio-tag.

According to one embodiment, the radio-tag comprises an external identifier associated with the identification datum stored in the memory of the radio-tag. It may for example involve an alphanumeric code or a visual mark, associated with the radio-tag, and notably arranged thereon, or arranged on an object or a substrate (for example, a sheet of paper) on which the radio-tag is fixed or intended to be fixed.

The above connected luggage item assembly may also comprise one or several removable objects intended to be present in the luggage item, the radio-tags being fixed either permanently or temporarily thereon.

Certain aspects of the invention start from the idea of providing a luggage item whose contents can be listed simply, quickly and reliably. Certain aspects of the invention start from the idea of carrying out a content check of a luggage item once the latter has been moved. Certain aspects of the invention start from the idea of informing a remote device of any insertion or removal of objects respectively in or from a luggage item. Certain aspects of the invention start from the idea of assisting the owner of a luggage item by informing him when an object needing to be in the luggage item is absent.

### BRIEF DESCRIPTION OF THE FIGURES

The invention will be better understood, and other aims, details, features and advantages thereof will appear more clearly, in the following description of several particular embodiments of the invention, provided solely as an illustrative and non-limiting example, in reference to the appended drawings.

FIG. 1 shows a luggage item comprising a radio-tag reader connected to a remote device, the luggage item containing objects provided with radio-tags.

FIG. 2 shows an operating diagram of the radio-tag reader of FIG. 1.

FIG. 3 shows a first operating mode of a remote device connected to the radio-tag reader of FIG. 1.

FIG. 4 shows a second operating mode of a remote device connected to the radio-tag reader of FIG. 1.

FIG. 5 shows a third operating mode of a remote device connected to the radio-tag reader of FIG. 1.

### DETAILED DESCRIPTION OF THE INVENTION

The description below is made in the context of a luggage item such as a leather accessory in the form of a purse comprising a radio-tag reader connected to a mobile telephone. However, the luggage item according to the invention may assume any other form, for example a backpack, a suitcase, a pouch, a satchel or the like. It may also be a toolbox, a briefcase, a chest or box, or a kit, for example.

The invention is notably applicable in fields where monitoring of the contents of a luggage item is of particularly major security importance. For example, the luggage item according to the invention may be a toolbox for aircraft maintenance operations (in which case the objects bearing radio-tags are tools for aircraft maintenance). It is in fact critical to check the presence of all of the tools in the luggage item at the end of maintenance operations, to prevent any tools from being forgotten on the aircraft itself, which could lead to an accident. Also for example, the luggage item according to the invention may be a suitcase or a box containing surgical instruments (bearing radio-tags); once again, it may be critical to check that all of the provided surgical instruments are indeed present in the luggage item, both at the beginning and the end of the operation during which they are brought to be used.

Likewise, the remote device connected to the radio-tag reader may assume many forms, for example a smartwatch, a computer, a multimedia unit or other.

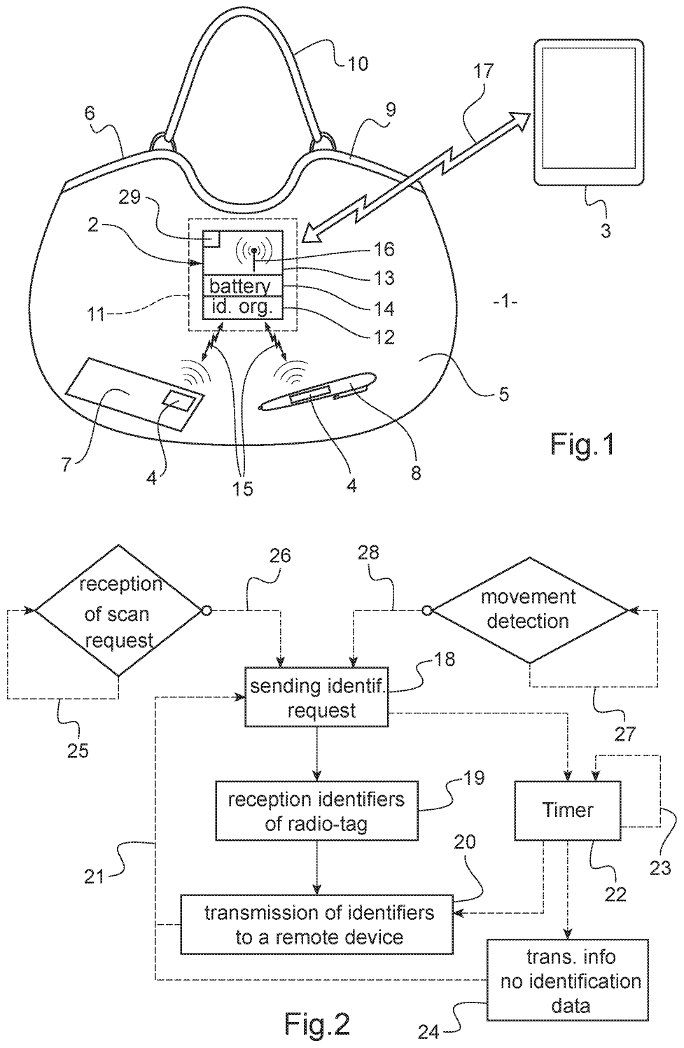

FIG. 1 shows a purse 1 comprising a radio-tag reader 2 connected to a remote device such as a mobile telephone 3, the purse 1 containing objects bearing radio-tags 4.

The purse 1 comprises a casing 5 delimiting an internal space of the purse 1 in which various objects are arranged that are intended to be transported by using the purse 1. The casing 5 further comprises an opening 6 making it possible to introduce or remove objects into or from the purse 1. For example, the purse 1 illustrated in FIG. 1 contains a wallet 7 and a pen 8.

The purse 1 can be made in various ways and assume a plurality of forms. Likewise, this purse 1 can be made from different materials, for example fabric, leather, plastics or other.

In the embodiment illustrated in FIG. 1, the casing 5 is made up of two substantially parallelepiped pieces of leather, three sides of which are connected to one another. The fourth sides of the two pieces of leather are located across from one another and are left free in order to form the opening 6 of the purse 1.

In one embodiment that is not illustrated, the purse comprises a piece of material forming a bottom of the purse and a plurality of pieces of material forming walls of the purse. Each piece of material forming one of the walls of the purse is on the one hand connected to one side of the piece of material forming the bottom of the purse, and on the other hand connected to one side of the pieces of material forming the adjacent walls of the purse. The end opposite to the bottom of the purse of the pieces of material forming the walls of the purse are left free to form the opening of the purse.

Preferably, the casing 5 comprises a member for obstructing the opening 6, for example a zipper, a scratch closure or snaps. In FIG. 1, this obstructing member is schematically illustrated by a closing strip 9. The purse 1 further comprises handles 10 allowing it to be transported easily. These handles 10 are mounted on the casing 5, for example at the closing strip 9.

The casing 5 comprises, in the internal space of the purse 1, an internal pouch 11, illustrated in dotted lines in FIG. 1. This internal pouch 11 forms a housing for the radio-tag reader 2. Preferably, the pouch 11 is located close to the opening 6. Thus, any object entering or exiting the internal space of the purse 1 passes close to the pouch 11 and therefore the radio-tag reader 2. The radio-tag reader 2 is preferably removable and can be removed from the pouch 11 so as for example to be installed in another luggage item (not shown). The radio-tag reader 2 comprises an electronic card on which an identification member 12, a wireless communication module 13 and a power supply 14 are arranged. Preferably, the radio-tag reader is of the RFID type.

The identification member 12 is of any type making it possible to emit an identification request destined to radio-tags 4 located in a nearby environment. The emitting distance is preferably selected based on the internal space of the luggage item in which the radio-tag reader is arranged, for example about 50 cm in the case of the purse 1. This identification member 12 emits the radiofrequency identification request, for example at a frequency of 13.56 MHz or 865 MHz, omnidirectionally. Furthermore, this identification member 12 is able to receive identification data in response to the sending of the identification request. The communication between the radio-tag reader 2 and the radio-tags 4, i.e., on the one hand the sending of the identification request and the reception of the identification data by the radio-tag reader 2, and on the other hand the reception of the identification request and the sending of the identification data by the radio-tag 4, is schematically illustrated by the arrows 15 in FIG. 1.

The wireless communication module 13 comprises an antenna 16. This wireless communication module 13 is for example a module using the Bluetooth or Wi-Fi technology or any other wireless communication mode making it possible to establish a wireless communication 17 between the radio-tag reader 2 and the mobile telephone 3. The wireless connection 17 between the radio-tag reader 2 and the mobile telephone 3 allows the transmission to the mobile telephone 3 of the identification data received by the radio-tag reader 2 from the radio-tags 4. This wireless connection 17 also allows the reception by the radio-tag reader 2 of requests for the contents of the purse 1 coming from the mobile telephone, as explained below.

It is also possible to provide that the wireless communication module 13 is configured to establish a communication by wireless connection with two separate remote devices. The wireless connection can be different with the two remote devices, for example a Bluetooth connection with one and a Wi-Fi connection with the other. The one of the remote devices can for example be a mobile device such as a dedicated electronic unit or a mobile telephone, and the other remote device can for example be a server. This system offers optimal security, for applications in which one wishes to carry out a double verification of the presence of objects in the luggage item. For example, for a toolbox, the presence of anticipated tools in the box (for example at the end of maintenance operations) can be checked both by the operator provided with a mobile remote device, and by a verification system independent of the operator (via a server).

The power supply 14 is of any type allowing the operation of the radio-tag reader 2, for example a lithium battery or other. The removability of the radio-tag reader 2 allows it to be removed from the pouch 11 to facilitate recharging of the power supply 14.

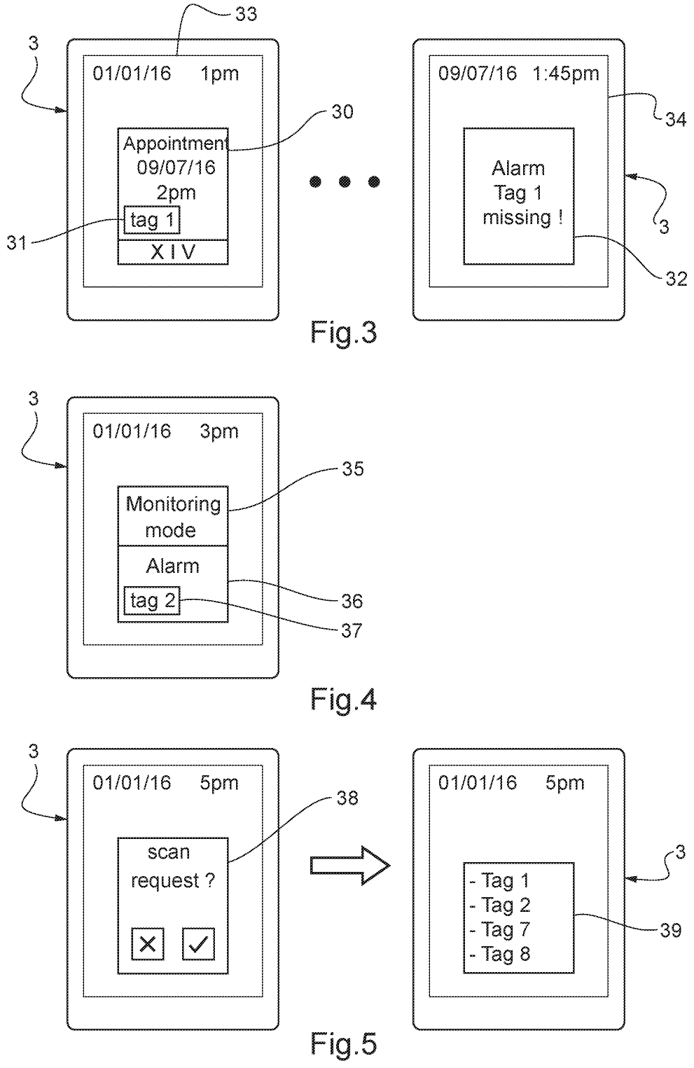

As explained below in light of FIGS. 3 to 5, the mobile telephone 3 advantageously comprises an application dedicated to managing the radio-tag reader 2 and radio-tags 4.

The radio-tags 4 are for example passive radio-tags not including an independent power source. Such passive radio-tags 4 are for example of the RFID type and comprise a substrate on which an antenna and a silicon chip are fixed. However, the radio-tags 4 can also be active radio-tags comprising an independent power source such as a lithium battery or other.

The radio-tags 4 can be removable and/or repositionable. They are then fixed on objects before the latter are introduced into the luggage item. In certain embodiments, they can be removed from the objects after use (so as to be optionally reused later by associating them with other objects). The substrate of the radio-tags 4 preferably comprises an adhesive face in order to fix the radio-tag 4 on an object. Alternatively, the radio-tags 4 can be integrated permanently into the objects in question when the latter are manufactured. For example, tools, surgical instruments, computers, cameras or any other objects can be directly equipped with radio-tags 4 allowing them to be detected.

The antenna of the radio-tags 4 makes it possible to receive identification requests from the radio-tag reader 2. Furthermore, in the case of passive radio-tags 4, the antenna of the radio-tag 4 also allows the reception of the energy necessary for its operation from the radio-tag reader 2.

The silicon chip comprises an internal memory in which an identification datum is stored. In response to the reception of the identification request from the radio-tag reader 2, the radio-tag 4 transmits to the radio-tag reader 2 the identification datum stored in its internal memory via its antenna.

Preferably, the identification datum stored in the internal memory of the radio-tag 4 is also accessible in a second form, for example in the form of a visual mark such as a barcode or a QR code, for example. The visual mark can be accessible on the substrate of the radio-tag, for example directly engraved or marked thereon. Alternatively, the visual mark can be separate from the radio-tag. It may notably be fixed to the corresponding object by a separate tag, or even be integrated permanently into the corresponding object. It may also be present on a separate substrate, on which the radio-tag (of the removable type) is fixed before being detached and fixed on an object.

As explained below, the accessibility of the identification data stored in the internal memory of the radio-tag in a second form makes it possible to associate this identification datum with a dedicated naming on the mobile telephone 3.

The radio-tag 4 can be fixed on any object intended to be introduced into the purse 1 and whereof one wishes to check the presence in the purse 1, for example the wallet 7, the pen 8 or even glasses, a cardholder, documents, etc.

FIG. 2 schematically illustrates the operation of the radio-tag reader 2 according to different operating modes.

The radio-tag reader 2 can be configured to operate according to different operating modes. The configuration of the radio-tag reader 2 can be done by any appropriate means, for example by using a dedicated remote control connected to or integrated into the radio-tag 2 to configure it, or even preferably by means of the mobile telephone 3. FIG. 2 non-limitingly illustrates three possible operating modes for the radio-tag reader 2, these operating modes being able to be carried out by the radio-tag reader 2 exclusively or, on the contrary, in parallel.

A first operating mode provides that the radio-tag reader 2 checks the contents of the purse 1 regularly and autonomously. When this first operating mode is activated, the radio-tag reader 2 emits an identification request (step 18). This identification request is received by the radio-tags 4 located in the environment close to the radio-tag reader 2. In response to this identification request, the radio-tags 4 located in the environment close to the radio-tag reader 2 transmit to the radio-tag reader 2 their identification data. The radio-tag reader 2 thus receives the identification data from all of the radio-tags 4 in its nearby environment, i.e., in the purse 1 (step 19). If the radio-tag reader 2 is connected to the mobile telephone 3 via the wireless connection 17, the radio-tag reader 2 transmits the received identification data to the mobile telephone 3 (step 20). If the radio-tag reader 2 is not connected to the mobile telephone 3, then it restarts, optionally after a certain predetermined amount of time, sending an identification request (18) in order to retry transmitting the identification data to the mobile telephone 3 thereafter.

Preferably, the radio-tag reader 2 comprises a clock (not illustrated) making it possible to monitor the time elapsed since sending the identification request (step 22). The radio-tag reader 2 waits for identification data as long as the time elapsed since sending the identification request has not exceeded a predetermined threshold (step 23). When the time elapsed since sending the identification request reaches the predetermined threshold, the radio-tag reader transmits the received data to the mobile telephone 3 (step 20) if the wireless connection 17 is established. As described above, if the wireless connection 17 is not established, the radio-tag reader sends a new identification request. If no identification data is received from the radio-tags, the radio-tag reader 2 transmits to the mobile telephone 3 information of absence of identification data to the remote device (step 24).

In this autonomous operating mode, the steps of sending an identification request (step 18), receiving identification data (step 19), transmitting received identification data (step 20), and optionally checking the elapsed time (steps 22 and 23) as well as transmitting information of absence of identification data (step 24), are repeated periodically by the radio-tag reader 2 (step 21). The periodicity of repetition of the identification requests can be configured according to the needs, from around several milliseconds for “continuous” checking to several minutes or even hours for less strict checking.

In a second operating mode, the radio-tag reader 2 monitors the reception of a request for contents of the purse 1 (step 25). When it receives a request for contents of the purse (step 26), the radio-tag reader 2 carries out the steps of sending an identification request (step 18), receiving identification data (step 19) and transmitting identification data (step 20) to the mobile telephone 3 similarly to the first operating mode described above. In this second operating mode, the radio-tag reader 2 can also carry out the steps of checking the elapsed time and sending information of absence of identification data (steps 22 and 23) as described above.

In a third operating mode, the purse 1 comprises a movement sensor 29 (see FIG. 1). This movement sensor 29 can be of any type making it possible to detect a movement of the movement sensor 29, for example an inertial unit, an accelerometer, a gyrometer or other. Such a movement sensor 29 can be integrated into the purse in different ways.

In one preferred embodiment illustrated in FIG. 1, the movement sensor 29 is integrated into the radio-tag reader 2. In another preferred embodiment that is not illustrated, the movement sensor is integrated into the casing of the purse and connected to the radio-tag reader 2. The movement sensor 29 is preferably arranged close to the opening 6 of the purse 1. For example, when the movement sensor 29 is integrated into the radio-tag reader 2, the radio-tag reader 2 is advantageously positioned in the pouch 11 close to the opening 6. Thus, when an object is placed in or removed from the purse 1 via the opening 6, the movement sensor 29 automatically detects the movement of the opening 6 of the purse 1 intended to make it possible to introduce or remove the object into or from the purse 1.

In this third embodiment, the movement sensor 29 monitors the movements of the purse 1 (step 27). When a movement of the purse 1 is detected by the movement sensor 29 (step 28), the radio-tag reader 2 carries out the steps of sending an identification request (step 18), receiving identification data (step 19) and transmitting identification data (step 20) to the mobile telephone 3 similarly to the first operating mode described above. The radio-tag reader 2 can also carry out the steps of checking the elapsed time and sending information of absence of identification data (steps 22 and 23) as described above. This operating mode is particularly energy-efficient, since the radio-tag reader 2 only emits an identification request when a movement of the purse 1 is detected and remains in standby mode the rest of the time, i.e., when the purse 1 does not move. Furthermore, this operating mode is particularly suitable for monitoring the purse 1, since it makes it possible to inform the mobile telephone 3 of the contents of the purse 1 when the latter is moved, for example when an object is removed from the purse 1. Likewise, when the purse is deposited somewhere, its owner is informed on his/her mobile telephone 3 when someone else moves the purse 1.

In addition to or instead of the movement sensor 29, a position sensor can be provided on the luggage item (for example, a magnetic or infrared sensor). The position sensor can be configured to detect a position of the luggage item relative to one or several reference marks. The radio-tag reader can be connected to the position sensor and for example configured to emit an identification request in response to the detection of a position of the luggage item relative to a reference mark. For example, when the luggage item (such as a toolbox) is deposited in its dedicated storage location, an identification request can be emitted to verify its contents.

In another embodiment, the radio-tag reader 2 itself can provide a position sensor function relative to a reference mark, which can be a radio-tag. The radio-tag reader 2 can thus be configured to emit an identification request when the proximity of the radio-tag to the reference mark is detected.

In another embodiment, the luggage item comprises an identification datum, for example a radio-tag or a visual mark, capable of being detected by a fixed (external) sensor. The fixed sensor is connected to a communication module capable of communicating with the radio-tag reader 2, for example to command it to emit an identification request when the proximity of the luggage item to the sensor is detected.

The three operating modes described above in reference to FIG. 2 can be carried out exclusively or in parallel. The operating mode of the radio-tag reader 2 is preferably determined by the mobile telephone 3 based on information requested by the mobile telephone 3.

The rest of the description describes examples of functions of the mobile telephone 3 in order to interact with the radio-tag reader 2. A dedicated application installed on the mobile telephone 3 makes it possible on the one hand to associate the radio-tags 4 with selected objects and, on the other hand, to control the operating mode of the radio-tag reader 2.

When a radio-tag 4 is fixed on an object, it is preferable to be able to identify, on the mobile telephone 3, the object associated with the radio-tag 4 by means of a dedicated name. Thus, when the radio-tag reader 2 transmits to the mobile telephone 3 the identification datum stored in the internal memory of the radio-tag 4, the mobile telephone 3 can indicate the name associated with this radio-tag 4 to its owner. For example, when the substrate of the radio-tag 4 comprises a QR code (or more generally when a visual mark is associated with the radio-tag, on the latter or on the corresponding object or on a separate substrate), this QR code can be scanned by the mobile telephone 3. The owner defines on and stores in his mobile telephone 3, a name to be associated with this QR code and therefore with the radio-tag 4 displaying this QR code (or this name can be obtained automatically by using a library of names). The mobile telephone 3 can thus subsequently directly display the name given to the object on which the radio-tag 4 is fixed. In one alternative, the identification number on the substrate of the radio-tag 4 is entered manually into the mobile telephone 3 and associated with a dedicated name.

FIG. 3 illustrates a first example of computer application carried out on the mobile telephone 3 making it possible to configure the operation of the radio-tag reader 2. The computer application installed on the mobile telephone 3 makes it possible to schedule appointments and associate a content alarm therewith. Firstly, illustrated by the display 33 of the mobile telephone 3 in FIG. 3, the owner of the mobile telephone 3 uses the computer application to schedule a future appointment 30. The owner of the mobile telephone 3 wishes, for this appointment, to take a specific object, for example a work document. The owner of the mobile telephone 3 therefore attaches a radio-tag 4 on this object. The owner of the mobile telephone 3 associates the identifier 31 “tag 1” with this radio-tag 4. This association between the radio-tag 4 and the identifier 31 is for example done by using a QR code present on the radio-tag 4 (or more generally by using a visual mark associated directly or not with the radio-tag). The owner specifies in the definition of the appointment 30 that he wishes to take the object identified by the identifier 31 “tag 1”.

The computer application thus makes it possible to define an alert date and time to verify the presence of the desired object in purse 1 before the appointment, 15 minutes before the appointment in the example illustrated in FIG. 3. At the time defined for the alert, the mobile telephone 3 establishes the wireless connection 17 between the mobile telephone 3 and the radio-tag reader 2. If the mobile telephone 3 does not manage to establish the wireless connection 17, it may then display an error message to inform the owner. Once the wireless connection 17 is established, the mobile telephone 3 sends the radio-tag reader 2 a content request. The radio-tag reader 2 then generates and sends an identification request. The radio-tag reader 2 next transmits the received identification data, or if applicable a message of absence of identification data, to the mobile telephone 3. If the identification code stored in the internal memory of the radio-tag 4 corresponding to the identifier 31 “tag 1” is present in the identification data transmitted by the radio-tag reader 2, then the mobile telephone 3 indicates to its owner that the object “tag 1” is indeed in the purse 1. Otherwise, i.e., if the identification code stored in the memory of the radio-tag 4 associated with the identifier 31 “tag 1” is not transmitted by the radio-tag 2, then the mobile telephone 3 generates an alert message 32 indicating that the object corresponding to the identifier 31 “tag 1” is missing from the purse 1. Such an alert message 32 is illustrated by the display 34 of the mobile telephone 3 shown in FIG. 3. The owner of the mobile telephone 3 is thus informed that the purse 1 does not contain the object he/she wishes to bring to his/her appointment and may therefore go look for it to place it in the purse 1.

FIG. 4 illustrates a second example of computer application carried out on the mobile telephone 3 making it possible to configure the operation of the radio-tag reader 2. The computer application installed on the mobile telephone 3 makes it possible to define a mode called “monitoring mode” 35 in which the radio-tag reader 2 emits an identification request periodically. The mobile telephone 3 receives the identification data obtained through these identification requests and can thus check the evolution of the contents of the purse 1. Thus, if an object marked by a radio-tag 4 is present during a first identification request but missing during the following identification request, the mobile telephone 3 can generate an alarm message 36 indicating that this object, having an identifier 37 “tag 2” in the example illustrated in FIG. 4, has been removed from the purse 1. This computer application advantageously makes it possible to guarantee that no object on which a radio-tag 4 is fixed has been removed from the purse 1 without the owner of the mobile telephone 3 being informed. This computer application thus prevents a person other than the owner of the purse 1 and/or the mobile telephone 3 from stealing an object on which a radio-tag 4 is fixed contained in the purse 1 without the owner of the purse 1 and/or the mobile telephone 3 being informed. In one alternative, the monitoring mode can be activated when a prolonged movement of the purse 1 is detected, for example when a journey is carried out with the purse 1.

Similarly to the computer application described in light of FIG. 3, the computer application described in light of FIG. 4 can also display an error message on the mobile telephone 3 when the latter does not succeed in establishing the wireless connection 17.

FIG. 5 illustrates a third example of computer application carried out on the mobile telephone 3 making it possible to configure the operation of the radio-tag reader 2. In this third example, the owner of the mobile telephone 3 occasionally generates a content request intended for the radio-tag reader 2, as illustrated by the display 38 in FIG. 5. The mobile telephone 3 can, upon receiving identification data transmitted by the radio-tag reader 2, display the identifiers associated with all of the identification data received by the card reader, thus making it possible to obtain, simply and quickly, a list of the objects marked by a radio-tag 4 contained in the purse 1, as illustrated by the display 39 in FIG. 5.

In one embodiment, the radio-tag reader 2 further comprises a memory (not illustrated) to keep a history of the results of the identification requests sent. Thus, if the radio-tag reader 2 receives a content request but no movement of the purse 1 has been detected, and therefore no object has been removed from or placed in the purse 1, then the radio-tag reader 2 can simply transmit the identification data received during the last identification request contained in the memory of the radio-tag reader 2.

Advantageously, a same mobile telephone 3 can be associated with a plurality of separate radio-tag readers 2. In this case, the computer application installed on the mobile telephone 3 must make it possible to specify the radio-tag reader 2 with which the wireless connection 17 must be established.

Although the invention has been described in connection with several specific embodiments, it is obvious that it is by no means limited thereto and encompasses all the technical equivalents of the described means as well as combinations thereof if they fall within the scope of the invention.

The management and verification computer application of the radio-tag reader can be implemented in different ways by using centralized or distributed software and/or hardware components. Usable hardware components are ASIC specific integrated circuits, FPGA programmable logic networks or microprocessors. Software components can be written in different programming languages, for example C, C++, Java or VHDL. This list is not exhaustive. The application can be implemented under different operating systems, for example Android or other.

The use of the verb “have”, “comprise” or “include” and its conjugated forms does not exclude the presence of elements or steps other than those set out in a claim. The use of the indefinite article “a” or “an” for an element or a step does not, unless otherwise indicated, preclude the presence of a plurality of such elements or steps.

In the claims, any reference sign in parentheses cannot be interpreted as a limitation of the claims.

1. A luggage item intended to contain removable objects, the luggage item comprising:
a casing delimiting an internal space of the luggage item capable of containing the removable objects, the casing having an opening forming a passage between the internal space of the luggage item and an exterior environment of the luggage item; and
a radio-tag reader, the radio-tag reader comprising:
an identification module configured to emit, by radio frequency, an identification request destined for a radio-tag and to receive identification data from the radio-tag in response to the identification request,
a communication module configured to associate the radio-tag reader with a remote device by means of a wireless connection, the radio-tag reader being configured to transmit the identification data received in response to the identification request to the remote device, and
a power supply capable of powering components of the radio-tag reader.

2. The luggage item according to claim 1, wherein the luggage item comprises a movement sensor configured to detect a movement of the luggage item, the radio-tag reader being connected to the movement sensor of the luggage item and configured to emit an identification request in response to the detection of the movement by the movement sensor.

3. The luggage item according to claim 2, wherein the movement sensor comprises an accelerometer configured to detect an acceleration.

4. The luggage item according to claim 2, wherein the movement sensor is arranged on the radio-tag.

5. The luggage item according to claim 1, further comprising a position sensor configured to detect a position of the luggage item relative to one or several reference marks, the radio-tag reader being connected to the position sensor of the luggage item and for example configured to emit an identification request in response to the detection of the position of the luggage item relative to a reference mark.

6. The luggage item according to claim 1, wherein the radio-tag reader is arranged on the casing so as to detect the passage of a radio-tag by the opening of the casing.

7. The luggage item according to claim 1, wherein the casing of the luggage item comprises a bottom, a side wall developing from the bottom of the casing, an end of the side wall opposite to the bottom delimiting the opening of the casing, the radio-tag reader being located on the side wall of the casing at the end delimiting the opening of the casing.

8. The luggage item according to claim 1, wherein the radio-tag reader is removable.

9. The luggage item according to claim 1, wherein the communication module of the radio-tag reader is configured to receive a request to check contents of the luggage item, the radio-tag reader being configured to emit an identification request in response to the reception of the request to check the contents of the luggage item.

10. The luggage item according to claim 1, wherein the radio-tag reader is configured to emit identification requests at regular intervals, the radio-tag reader being configured to transmit, to the remote device, the identification data received in response to each identification request.

11. The luggage item according to claim 10, wherein the radio-tag reader comprises a memory, the radio-tag reader being configured to store the identification data received in response to one of the identification requests.

12. The luggage item according to claim 1, wherein the communication module is configured to associate the radio-tag reader with two separate remote devices.

13. A connected luggage item assembly including:
the luggage item according to claim 1,
the radio-tag comprising a transceiver able to receive a radiofrequency identification request and to transmit, in response and upon receiving the identification request, an identification datum stored in a memory of the radio-tag.

14. The connected luggage item assembly according to claim 13, wherein the radio-tag is a passive radio-tag.

15. The connected luggage item assembly according to claim 13, wherein the radio-tag comprises an external identifier associated with the identification datum stored in the memory of the radio-tag, the external identifier preferably being chosen from among an alphanumeric code and a visual mark.
